(19) United States
(12) Patent Application Publication
(10) Pub. No.: US 2026/0163048 A1
(43) Pub. Date: Jun. 11, 2026

(54) Device for Z-Shaped Folding of a Separator and Method for Producing an Electrode Separator Arrangement

(71) Applicant: Mercedes-Benz Group AG, Stuttgart (DE)

(72) Inventors: Malte Henrik KLEIN, Stuttgart (DE); Hendrik DUBBE, Stuttgart (DE)

(21) Appl. No.: 18/724,461

(22) PCT Filed: Nov. 7, 2023
(86) PCT No.: PCT/EP2023/081016

§ 371 Date: Jun. 26, 2024

(30) Foreign Application Priority Data
Dec. 1, 2022 (DE) 10 2022 004 504.4

(51) Int. Cl. H01M 10/04

(52) U.S. Cl. CPC H01M 10/0459; H01M 10/0404

(57) ABSTRACT

A device for z-shaped folding of a ribbon-like separator extending in a longitudinal direction for an electrode separator arrangement of an individual battery cell. The device includes two stamps for clamping the separator on its two ends in the longitudinal direction. Brackets are arranged between the two stamps which have the same spacing in relation to each other in the longitudinal direction, which have struts in a transverse direction, and which are received shiftably in the longitudinal direction on rails running in the longitudinal direction. The rails are formed to be moveable in a vertical direction transversely to the longitudinal direction and transversely to the transverse direction. When seen in the longitudinal direction, the struts are arranged alternately above and below the clamping position of the separator in the vertical direction.

### BACKGROUND AND SUMMARY OF THE INVENTION

The invention relates to a device for z-shaped folding of a ribbon-like separator extending in a longitudinal direction for an electrode separator arrangement of an individual battery cell. Moreover, the invention relates to two distinct methods for producing an electrode separator arrangement in stack form with the help of such a device.

The production of electrode separator arrangements is already known from the general prior art. In practice, three production methods have prevailed here, which are described in the article “Process and Performance Optimization by Selective Assembly of Battery Electrodes, Jan Schmitt et. al, CIRP Annals-Manufacturing Technology 63 (2014 ) 9-12”. Here, stacking individual separator sheets and electrodes is substantially described, as well as coiling electrodes and separators. A further method is the so-called z-shaped folding, which is generally referred to as “z-folding”. For this, an endless separator is used, on which an electrode is placed in each case before the separator is enveloped around or folded over this electrode, after which the next sheet-shaped electrode is placed on, which then has the respective opposite polarity. Subsequently, the separator is folded back again, the next electrode is placed on and so on. Here, the separator is continuously supplied as roll material and has to be correspondingly moved back and forth. The advantage of stacking or the z-folding here is that, in contrast to coiling, the electrodes are not bent, which can be a crucial advantage, in particular with solid body batteries. The advantage of coiling is that a very high production speed can be attained, which is not possible either with successive processes of stacking or z-folding.

JP 2003 243 270 A shows a substantially generic method in which the separator for an individual battery cell with electrodes laminated on is folded over moveable struts, in order to form a z-shaped folded electrode stack for a battery cell.

Moreover, JP 2009 140 776 A describes a similar processing of electrodes and separators to form a z-shaped folded electrode stack. Such a further method is also fundamentally known from DE 10 2018 200 958A 1 .

Finally, reference can be made to JP 2012 033 275 A, which also addresses this topic and specifies a device for the f-shaped folding of an electrode stack.

It is common to all methods that the struts used for the z-shaped folding have to be removed again from the stack or folded material. This is comparatively complex. To this end, a lateral extraction is shown and described in the prior art, for example in JP 2009 104 776 A and also JP 2012 033 275 A. This is always problematic when the electrodes are not already laminated fixedly to the separator, since then a slipping of the electrodes within the stack can be caused, which leads to production errors. The object of the invention present here is therefore to specify a device for z-shaped folding of a separator and suitable methods for producing an electrode separator arrangement therewith, which enables a high production speed.

The device according to the invention thus serves for the z-shaped folding of a ribbon-like separator extending in a longitudinal direction for an electrode separator arrangement of an individual battery cell. Here, the device comprises two stamps, which are set up to clamp the separator, which is cut to a length fitting for the method, on its two ends in the longitudinal direction. Brackets are arranged between the two stamps, the brackets having the same spacing in relation to each other in the longitudinal direction and comprising struts running transversely to the longitudinal direction. These brackets are received on rails in the longitudinal direction and can be shifted out of these rails in the longitudinal direction. The rails themselves can be moved in a vertical direction, which lies transversely both in relation to the longitudinal direction and in relation to the transverse direction, can thus be moved away from each other and towards each other. Seen in the longitudinal direction, the individual struts are located alternately above and below the clamping position of the separator in the vertical direction. If the separator is thus clamped between the stamps, one of the struts lies above and one of the struts lies below respectively alternating. If the rails are now moved away from each other, the brackets connected to the rails correspondingly exert forces on the struts, such that the separator is pulled downwards by one half of the struts and upwards by the other half of the struts. Here, the position of the two stamps in relation to each other also changes, since the separator is correspondingly shortened when seen in the pure longitudinal direction, since it now forms a z-shaped folded tape. In an end position of the stamps and the rails, the rails are moved as far away from each other as possible and the stamps are moved towards each other as far as possible, such that a z-shaped folded bundle of the separator comes to rest between the stamps.

According to the invention, it is provided here that the struts are formed to be able to be heated and/or a cutting device is provided to sever the separator in the region of the struts in a position of the stamps moved as close to each other as possible.

One variant further provides that the struts are also formed to be able to be heated. In particular with a separator that can be laminated, which can be laminated by the heated stamp to form the unit, this makes sense. It is also conceivable, in principle, with other separators.

In the final end product, the struts are unwanted. If these can now be correspondingly heated, these can be removed from the separator, for example, by them being heated and then the rails moved out beyond their end position. In doing so, the separators are melted in the region of the folds, and the struts can be extricated transversely to the running direction out of the separators through the melted material. When the pressure is correspondingly applied by the stamps at the same time, the melted parts are then melted together and, alternatively or additionally to the heated stamps, help to fix the unit.

Alternatively or additionally to this, a cutting device can also be provided to sever the separator in the region of the struts in a position of the stamps moved towards each other as far as possible. Additionally or alternatively to the use of heated stamps, such a cutting device can here help to correspondingly release the struts. Cutting can here be carried out mechanically, for example via a knife, a rolling knife or similar, or a laser can be used for cutting. These techniques are suitable, in particular, when a separator that is not capable of lamination is used, in which the material cannot be melted and/or severed using heat without damage.

According to a very advantageous development of the device according to the invention, it is provided here that the length of the struts in the transverse direction is formed to be greater than the width of the separator. Such wider struts improve the quality of the folding and allow the design of the brackets, for example, in a way that they hold the struts on both ends in the transverse direction, in order to thus be able to simultaneously exert traction on the separator via the struts when moving the rails apart.

According to a further very advantageous design of the device according to the invention, the stamps can be formed to be able to be heated. Such ability of the stamps to be heated enables, in particular, a lamination of the separator after recoiling the stamps to their end position as a result of heating, such that this is correspondingly melted in order to connect individual regions of the separator and thus to form a fixed unit made of the separator and electrodes typically introduced in advance.

In order to correspondingly coordinate the procedures of the device such that, in this, a separator can be folded in a z-shape, it can be provided according to a very advantageous design of the device according to the invention that this has a controller for coordinating the movement of the stamps and the rails, wherein this controller is set up, in particular, to move the rails away from each other in the manner already described above and to move the stamps towards each other to fold the separator, wherein the movements are designed to be coordinated between the rails and the stamps.

A method according to the invention for producing a stack-shaped electrode separator arrangement for an individual battery cell with a continuous separator can now provide that, in a method step, the electrodes are laminated onto the separator. In this case, on each of the surfaces of the separator in its longitudinal direction, an electrode will follow a free section with at least the length of the electrode and immediately. In doing so, the electrodes can thus be arranged alternately with free sections in the longitudinal direction of the separator, such that, after folding, in each case the one layer of the separator, with which the electrode is laminated, lies on the one side of the electrode and the other layer with the free section is folded onto the electrode. Here, it is further the case that electrodes of the same polarity in each case are arranged on each of the surfaces of the separator, i.e., for example the anodes above and the cathodes below. The electrodes of different polarity here lie at least partially opposite on the respective surfaces. At least partially in this context can mean that the number of anodes, for example, deviates from the number of cathodes, such that only one of the electrodes is thus present to complete the fold in one of the edge regions of the separator. After such a semi-finished product is produced from the separator and the electrodes are laminated on, this semi-finished product is folded in a second method step in a z-shape in a device into one of the designs described above by the rails and the stamps being moved in their respective end position, as has already been indicated. Then, an electrode separator arrangement emerges from the semi-finished product, which is formed with a z-shaped folded separator.

According to a further method according to the invention, laminating the electrodes on can also be dispensed with, for example when a separator is used, which cannot be laminated. In this case, the separator is pre-folded, in a first method step in a device according to the design described above, by the rails and stamps being moved in the direction of their respective end position but stopped before reaching the respective end position. The separator is then in a z-shaped fold, but still has comparatively strongly opened pockets, which respectively point upwards and downwards or respectively to the side, depending on the arrangement of the device. Subsequently, all electrodes are now, for example, simultaneously shifted at the same time or in two steps one after the other, firstly all anodes then all cathodes, into the corresponding pockets, for examples the cathodes from below, the anodes from above or, with a rotated arrangement, correspondingly the cathodes from the left and the anodes from the right. Subsequently, in a third method step, the rails and stamps are moved into their respective end position. Now, here too without producing a semi-finished product made of electrodes and separators in advance, the corresponding z-shaped folded electrode separator arrangement emerges.

In the two methods according to the invention, a separator can here be fundamentally used, which is able to be laminated. In this case, in a further method step, the arrangement in the end position of the stamps can be fixed to form a unit, for which the stamps can be heated in a corresponding design in the sense described above, such that the unit emerges by laminating the separator. Alternatively to this, other methods for fixing the unit can also be applied, for example injecting an adhesive from the sides of the z-shaped fold, which are open laterally. In particular, adhesive tape can be used for fixing when the separator is not supposed to be laminated or melted.

According to the invention, when such a fixed unit is present, it is now provided that the separator is separated in the region of the struts of this fixed unit, in order to remove the struts from the unit. In the sense described above, this can be carried out, for example, by cutting with mechanical means or with a laser or also by melting the corresponding separator by the struts being heated and the rails of the device then being moved out apart from each other beyond the end position, in order to pull the struts through the melted material of the separator.

Further very advantageous designs of the device according to the invention and the method according to the invention also emerge from the exemplary embodiment, which is described in more detail below with reference to the figures.

### BRIEF DESCRIPTION OF THE DRAWINGS

FIG. 1 a side view of a device according to the invention in its initial position;

FIG. 2 a view according to line II-II in FIG. 1;

FIG. 3 a depiction analogous to that in FIG. 1 in a central position of the stamps and rails;

FIG. 4 a view according to line IV-IV in FIG. 3;

FIG. 5 a depiction analogous to that in FIG. 1 in an end position of the stamps and rails; and

FIG. 6 a view according to line VI-VI in FIG. 5.

### DETAILED DESCRIPTION OF THE DRAWINGS

By means of the figures below, the procedure for producing a z-shaped folded electrode separator arrangement is described using the example of a separator 1 that can be seen in FIG. 1 with electrodes 2 laminated on. Here, the separator 1 is clamped in a longitudinal direction x between two stamps 3. Here, first electrodes 2, for example anodes 2.1, are arranged on a surface of the separator 1 lying above in a vertical direction z, cathodes 2.2 respectively below. Sections of the separator 1 that are always empty are located in between these, which, in the longitudinal direction x, have at least the length of the electrodes 2 arranged next to them. In the section depicted on the far right, only one anode 2.1 is arranged, the cathode 2.2 is dispensed with here.

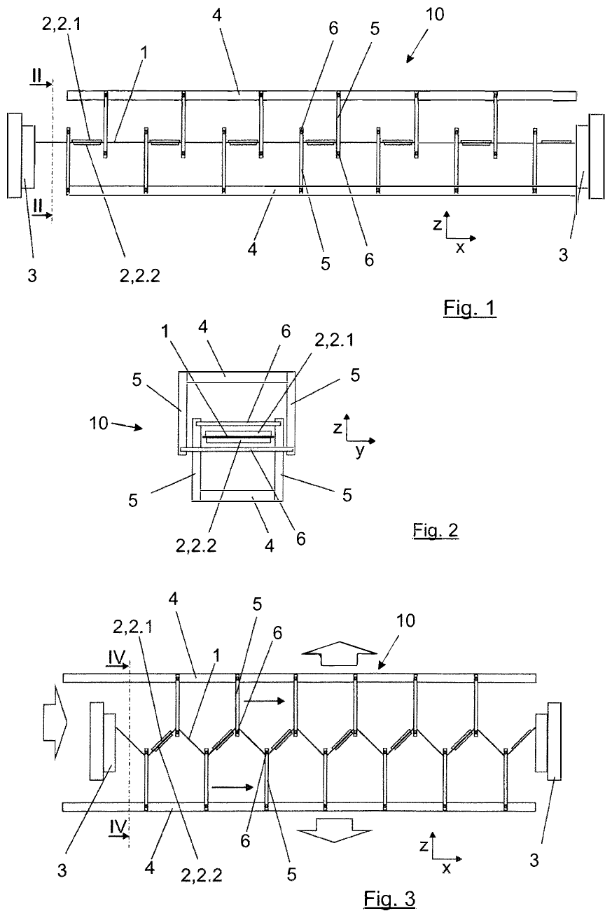

Along with the side view in FIG. 2, the construction can also correspondingly be seen in the view of FIG. 2 in a front view according to line II-II in FIG. 1. Here, the separator 1 can also be seen with the anode 2.1 at the top on the separator in the vertical direction z and the cathode 2.2 at the bottom on the separator in the vertical direction z. Now, two rails 4 run above and below the separator 1 in the longitudinal direction x, on which rails, as is depicted in FIG. 1, several brackets 5 are arranged, of which only two are provided with a reference numeral. As can be seen from the depiction of FIG. 2, these brackets 5 can be attached laterally on the rails in a transverse direction y. They can be shifted in opposition to the rails 4 in the longitudinal direction x. For their part, the brackets 5 now have struts 6, which run in the transverse direction y, and which can be seen, in particular, in the depiction of FIG. 2. Here, as can also be seen, in particular, in FIG. 1, these struts 6 are always arranged alternately above and below the separator 1 in the vertical direction z, namely always in the border regions between the region with the electrodes 2 and the free section.

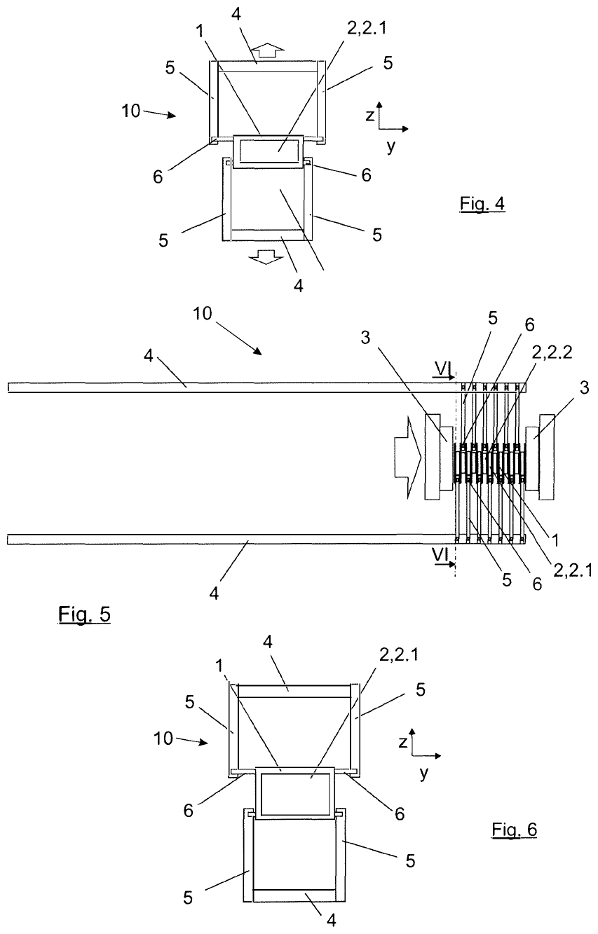

In order to create the desired electrode separator arrangement, the z-shaped folds of the separator 1 now begin by, on one hand, the stamps 3 being driven towards each other, for which the stamp 3 shown on the left is moved to the right in the figures depicted here. At the same time, the two rails 4 are moved apart from each other in order to thus apply traction on the separator via the brackets 5 and the struts 6 at the corresponding points. After the start of this movement of the device referred to in its entirety with 10, this is now in the position shown in FIGS. 3 and 4, analogous to the depiction in FIGS. 1 and 2. Looking from the left stamp 3, which is depicted again in FIG. 4, now shows one of the electrodes, here the anode 2.1, on the separator 1. The rails 4 and thus the struts connected to the rails 4 via the brackets 5 have been moved downwards apart from each other from above, in order to achieve the z-shaped fold of the separator 1 in the manner of an accordion. The individual brackets 5 all move in the longitudinal direction x towards the right stamp 3 and here ensure the desired arrangement of the separator 1.

This process, in which the rails 4 are pulled apart from each other and the stamps 3 are moved towards each other, is now correspondingly continued until the end position of the stamps 3 and the rails 4 depicted in FIG. 5 has been achieved. The two stamps 3 now crimp the electrode separator arrangement between them and can be heated, for example, in order to create a unit made of the separator 1 and the electrodes 2 with a separator 1 that is able to be laminated. Subsequently, the struts 6 are then removed from this unit, for which, for example in the region of the struts 6, the separator 1 can be separated, wherein this can be carried out mechanically, in particular, by a knife or preferably by heating the struts 6. The heated struts are then extracted from the unit by means of a movement of the rails 4 beyond their end position. The melted separator can then be combined again and the unit correspondingly tightly locked.

The alternatives described at the start, in which the electrodes 2 are not laminated onto the separator 1, would correspondingly stop the movement of the stamps 3 and the rails 4 in an intermediary position of the device 10 between the two positions shown in FIGS. 3 and 5, in order to place the electrodes into the pockets, for example all electrodes 2 at the same time or firstly the anodes 2.1 from above and then the cathodes 2.2 from below in the depiction of the figures. Following on from this, this would then be moved into the end position shown in FIG. 5. Instead of melting or heating the separator 1 to form the unit, here a lateral adhesion of the separator ends could then be carried out, for example using an adhesive mass, an adhesive tape or similar. Here, the struts 6 would also then be removed, for example by cutting the separators 1, which then in turn could be followed by adhering around it, for example with an adhesive tape.

1.-6. (canceled)

7. A device (10) for z-shaped folding of a ribbon-like separator (1) extending in a longitudinal direction (x) for an electrode separator arrangement of an individual battery cell, comprising:
two stamps (3) for clamping the ribbon-like separator (1) in the longitudinal direction (x);
brackets (5) disposed between the two stamps (3) which have a same spacing in relation to each other in the longitudinal direction (x) and which each have a respective strut (6) in a transverse direction (y) running transversely to the longitudinal direction (x); and
rails (4) moveable in a vertical direction (z) transversely to the longitudinal direction (x) and transversely to the transverse direction (y);
wherein, when seen in the longitudinal direction (x), the struts (6) are disposed alternately above and below a clamping position of the ribbon-like separator (1) in the vertical direction (z);
wherein the brackets (5) are received shiftably in the longitudinal direction (x) on the rails (4) running in the longitudinal direction (x);
wherein the struts (6) are formed to be heatable and/or wherein the device (10) further comprises a cutting device for severing the ribbon-like separator (1) in a region of the struts (6) in a position of the two stamps (3) moved as close to each other as possible.

8. The device (10) according to claim 7, wherein a length of the struts (6) in the transverse direction (y) is greater than a width of the ribbon-like separator (1) in the transverse direction (y).

9. The device (10) according to claim 7, wherein the two stamps (3) are formed to be heatable.

10. The device (10) according to claim 7, further comprising a controller for coordinating a movement of the two stamps (3) and the rails (4) which is configured to move the rails (4) away from each other and the two stamps (3) towards each other to fold the ribbon-like separator (1).

11. A method for producing a stack-shaped electrode separator arrangement for an individual battery cell having a continuous separator (1), comprising the steps of:
in a first method step, electrodes (2) are laminated onto the separator (1), wherein on each surface of the separator (1) in its longitudinal direction (x), an electrode (2) follows a free section with at least a length of the electrode (2);
after the first method step, in a second method step, a semi-finished product made of the separator (1) and the electrodes (2) is folded in a z-shape in the device (10) according to claim 7 by the rails (4) and the two stamps (3) moving into a respective end position to form a stacked-shaped electrode separator arrangement;
after the second method step, in a third method step, the stacked-shaped electrode separator arrangement is fixed in the end position of the two stamps (3) to form a unit; and
in a fourth method step, in the unit, the separator (1) is separated in a region of the struts (6) to remove the struts (6) from the unit.

12. A method for producing a stack-shaped electrode separator arrangement for an individual battery cell having a continuous separator (1), comprising the steps of:
in a first method step, the separator (1) is pre-folded in a z-shape in the device (10) according to claim 7 by the rails (4) and two stamps (3) moving in a direction of a respective end position and stopping before reaching the respective end position;
after the first method step, in a second method step, electrodes (2) are shifted into respective pockets of the z-shaped folded separator (1);
after the second method step, in a third method step, the rails (4) and the two stamps (3) are shifted into their respective end position to form a stacked-shape electrode separator arrangement;
after the third method step, in a fourth method step, the stacked-shaped electrode separator arrangement is fixed in the end position of the two stamps (3) to form a unit; and
in a fifth method step, in the unit, the separator (1) is separated in a region of the struts (6) to remove the struts (6) from the unit.
